(19) United States
(12) Patent Application Publication
(10) Pub. No.: US 2004/0061711 A1
(43) Pub. Date: Apr. 1, 2004

(54) Image display device, image display method, and image display program

(75) Inventors: Takashi Kurumisawa, Shiojiri-shi (JP); Masanori Ishida, Kagoshima-shi (JP); Kiyoaki Murai, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/633,624

(22) Filed: Aug. 5, 2003

(30) Foreign Application Priority Data
Aug. 22, 2002 (JP) 2002-242480

(51) Int. Cl. G09G 5/02

(52) U.S. Cl. 345/698

(57) ABSTRACT

The invention provides a method for converting resolution of image data which is capable of making a high-resolution image data without incompatibility by improving a viewing angle range when displaying low-resolution image data after resolution conversion. The image display device can be mounted in a mobile phone or PDA, processes and displays image data transmitted from the outside. Specifically, resolution-converted image data with an increased resolution is generated by creating a plurality of pixels from each pixel constituting the original acquired image data and increasing the number of the pixels. This is achieved by doubling each pixel of the original image data in the horizontal and vertical directions to make it four pixels. For the resolution-converted image data obtained by doing so, a viewing angle range adjustment is carried out. Specifically, adjacent pixels in a vertical direction of the resolution-converted image data are set so that each grayscale value of the pixels is different from each other. In this regard, in the resolution-converted image data, bright pixels and dark pixels are arranged adjacent in the vertical direction and thus a vertical viewing angle range is enlarged. Therefore, the resolution-converted image data is displayed on the display unit. In case that resolution conversion step is performed with respect to the original image data as mentioned above, the image data after the conversion can have a wide viewing angle range.

### BACKGROUND OF THE INVENTION

1. Field of Invention

The present invention relates to a method for converting resolution of image data.

2. Description of Related Art

Recently, the screen size of display devices mounted in portable terminal devices, such as mobile telephones or PDAs (personal digital assistant), has increased and the resolution has improved. Therefore, it is possible to display high-resolution image data with a higher number of pixels on a larger screen compared to a conventional technology.

However, high-resolution image data corresponding to such a large screen display or a high resolution display (hereinafter, referred to simply as a high resolution display) has a large amount of data. Therefore, there is a problem in that communication expenses are higher than necessary in transmitting and receiving the high-resolution image data. Also, a service provider who provides various contents to portable terminal devices must prepare the high-resolution image data in addition to image data corresponding to the size of conventional screens and must provide the high-resolution image data to users with high resolution display devices. As a result, the service provider must prepare and keep various types of image data. Therefore, there is a problem in that development expenses and equipment costs increase.

### SUMMARY OF THE INVENTION

In view of these points, a method of using properly image data corresponding to the size of the screen of the conventional portable terminal device and the high-resolution image data is considered. In other words, in the case of a service of providing contents performed enough by using the image data corresponding to a normal screen size, the image data corresponding to the conventional screen size (hereinafter, referred to as low resolution screen data for convenience) is transmitted and received. In the case of a service of providing contents where it is requested to display a high-resolution image, the high-resolution image data is transmitted and received.

When the high-resolution image data is received, a portable terminal device corresponding to high resolution displays the high-resolution image data as it is. When the low-resolution image data is received, the portable terminal device converts resolution to create the high-resolution image data without incongruity and displays the high-resolution image data.

As a display device of the above-mentioned portable terminal device, a liquid crystal display device is being widely used because it is a small-sized and light-weight. However, the liquid crystal display device essentially has a problem in viewing angle range, so its color characteristics changes or its contrast is degraded depending on the observation direction for a liquid crystal panel. In addition, a TN (Twisted-Nematic) mode liquid crystal particularly has a property that a vertical viewing angle range is narrow.

Accordingly, an object of the present invention is to provide a method for converting resolution of image data which is capable of making high-resolution image data without incompatibility by improving a viewing angle range when displaying low-resolution image data after resolution conversion.

In accordance with a first aspect of the present invention, there can be provided an image display device, that can include a display unit, a resolution conversion device for making a plurality of pixels from each pixel of original image data and generating resolution-converted image data including the plurality of created pixels, a viewing angle range adjustment device for setting grayscale values of each pixel of the resolution-converted image data so that the grayscale values of the adjacent pixels in a vertical direction of the resolution-converted image data are different from each other, and a display device for displaying the resolution-converted image data on the display unit.

The above image display device can be mounted in a mobile phone or PDA, processes and displays imaged data transmitted from the outside. Specifically, resolution-converted image data with an increased resolution is generated by creating a plurality of pixels from each pixel constituting the original acquired image data and increasing the number of the pixels. This is achieved by doubling each pixel of the original image data in the horizontal and vertical directions to make it four pixels. For the resolution-converted image data obtained by doing so, a viewing angle range adjustment is carried out. Specifically, adjacent pixels in a vertical direction of the resolution-converted image data can be set so that each grayscale value of the pixels is different from each other. In this regard, in the resolution-converted image data, bright pixels and dark pixels are arranged adjacent in the vertical direction, and thus a vertical viewing angle range is enlarged. Therefore, the resolution-converted image data is displayed on the display unit. In case that resolution conversion step is performed with respect to the original image data as mentioned above, the image data after the conversion can have a wide viewing angle range.

In one aspect of the above image display device, the viewing angle range adjustment device can set the difference between grayscale values of the adjacent pixels in a vertical direction to be more than a predetermined grayscale value. In this way, it is possible to surely improve a viewing angle range by making the difference of more than the predetermined grayscale value.

In another aspect of the above image display device, the viewing angle range adjustment device can set the grayscale value of each pixel based on the display characteristics of the display unit. In this regard, since the grayscale value of each pixel is set based on the characteristics of the display unit actually displaying image data, it is possible to achieve a resolution conversion and display image data with an improved angle and with a proper brightness and color.

In another aspect of the above image display device, the viewing angle range adjustment device can include a lookup table for storing the display characteristics of the display unit and device for determining the grayscale value of each pixel with reference to the lookup table. In this regard, the grayscale value of each pixel can be determined according to the display characteristics by a simple process of acquiring a pixel value from the lookup table previously storing the characteristics of the display unit.

In another aspect of the above image display device, the viewing angle range adjustment device can set the grayscale values of sub pixels constituting each pixel of the resolution-converted image data such that the adjacent sub pixels in the vertical direction can have different grayscale values. In this regard, a viewing angle range is improved because the grayscale values in sub pixel unit and in the vertical direction are different from each other. In addition, it is possible that the difference of the grayscale values of the adjacent sub pixels in the vertical direction is not noticed when observed by human being.

In another aspect of the image display device, the viewing angle range adjustment device includes a lookup table for storing the display characteristics of the display unit for each color of R, G, and B; and a device for determining the grayscale values of the sub pixels for each color with reference to the lookup table.

It is known that the viewing angle range characteristics are different according to each color of R, G, and B. Thus, it is possible to improve a viewing angle range more properly by determining the grayscale values of the sub pixels for each color according to the display characteristics of each color of R, G, and B.

In another aspect of the image display device, the image display device can further include an input unit receiving a command to select one between a wide viewing angle range and a narrow viewing angle range. The display device displays the resolution-converted image data adjusted by the viewing angle range adjustment device if the wide viewing angle range mode is selected and displays the resolution-converted image data not adjusted by the viewing angle range adjustment device if the narrow viewing angle range mode is selected.

According to this aspect, the user of the image display device can select any one of the wide viewing angle range mode and the narrow viewing angle range mode according to its preference. In case that the wide viewing angle range mode is selected, a viewing angle range is improved by giving a grayscale difference to the pixels constituting the resolution-converted image data in the vertical direction. Meanwhile, in case that the narrow viewing angle range mode is selected, such a grayscale difference is not given and the image data is displayed without enlarging a viewing angle range.

Another aspect of the present invention provides an image display method to be executed in an image display device with a display unit, comprising a resolution conversion step for making a plurality of pixels from each pixel of original image data and generating resolution-converted image data including the plurality of made pixels, a viewing angle range adjustment step for setting the grayscale value of each pixel of the resolution-converted image data so that the grayscale values of the adjacent pixels in the vertical direction of the resolution-converted image data are different from each other, and a display step for displaying the resolution-converted image on the display unit.

According to the above image display method, like the above-described image display device, in case that a resolution conversion step is performed with respect to the original image data, the image data after the conversion can have a wide viewing angle range.

The third aspect of the present invention provides an image display program to be executed in the image display device having a display unit and a computer, the image display program making the computer functions as a resolution conversion device for making a plurality of pixels from each pixel of original image data and generating resolution-converted image data including the plurality of made pixels, a viewing angle range adjustment device for setting the grayscale value of each pixel of the resolution-converted image data so that the grayscale values of the adjacent pixels in the vertical direction of the resolution-converted image data are different from each other, and a display device for displaying the resolution-converted image data on the display unit.

By executing the image display program by the computer in the image display device having the display unit, in case that a resolution conversion step is performed with respect to the original image data, the image data after the conversion can have a wide viewing angle range.

### BRIEF DESCRIPTION OF THE DRAWINGS

The invention will be described with reference to the accompanying drawings, wherein like numerals reference like elements, and wherein:

FIG. 1 shows a schematic construction of a portable terminal device in which a resolution conversion step according to the present invention is applied;

FIG. 2 shows schematically a resolution conversion method that is accompanied by a simple resolution conversion step and a viewing angle range adjustment;

FIG. 3 shows schematically a resolution conversion method in which a viewing angle range adjustment is performed for each RGB;

FIG. 4 is a view for explaining the concept of a viewing angle range adjustment method in consideration of the display characteristics of a display device;

FIG. 5 shows schematically the viewing angle range adjustment method in consideration of the display characteristics of the display device;

FIG. 6 shows an example of a pattern capable of improving a viewing angle range;

FIG. 7 is a flow chart of a display control step by the portable terminal device; and

FIG. 8 is a flow chart of the display control step capable of selecting a viewing angle range mode.

### DETAILED DESCRIPTION OF PREFERRED EMBODIMENTS

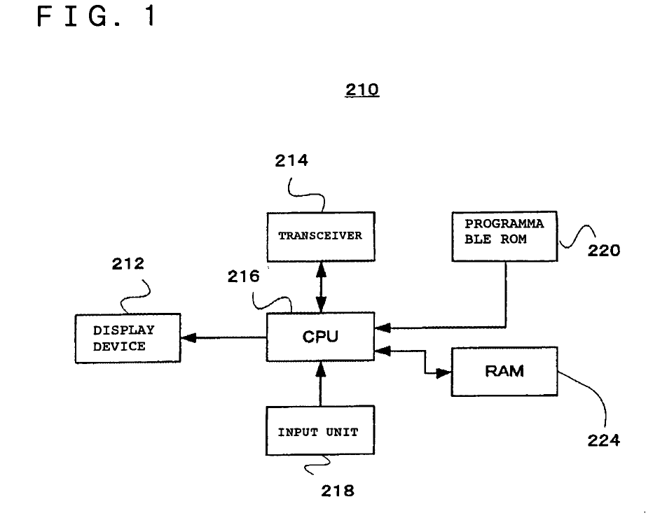

Hereinafter, a preferred embodiment of the present invention will be described with reference to the drawings. FIG. 1 illustrates a schematic structure of an exemplary portable terminal device, to which a resolution converting method according to an embodiment of the present invention is applied. In FIG. 1, a portable terminal device 210 is a terminal device, such as a mobile telephone or a PDA. The portable terminal device 210 can include a display device 212, a transceiver unit 214, a CPU 216, an input unit 218, a programmable ROM 220, and a RAM 224.

The display device 212 may be a light and thin display device, such as a LCD (liquid crystal display), and displays image data in a display area. The display device 212 can high resolution display where the number of pixels in horizontal and vertical directions is, for example, 240×320 dots.

The transceiver unit 214 receives image data from the outside. For example, a user manipulates the portable terminal device 210 to connect to a server device for performing a service of providing contents, input a command of downloading desired image data, and then image data is received. Also, in the case of receiving face image data from the portable terminal device of another user, the transmitting and receiving unit 214 receives the image data. The image data received by the transmitting and receiving unit 214 can be stored in the RAM 224.

The input unit 218 may include various manipulation buttons in the case of the mobile telephone and a tablet for detecting contact by a touch pen in the case of the PDA and is used for a user to perform various commands and selections. The commands and the selections input by the inputting unit 218 are converted into electrical signals and are sent to the CPU 216.

The programmable ROM 220 stores various programs for executing various functions of the portable terminal device 210. In particular, in the present embodiment, the programmable ROM 220 stores an image display program for displaying image data on the display device 212 and a resolution conversion program for converting the low-resolution image data into the high-resolution image data and displaying the high-resolution image data on the display device 212.

The RAM 224 is used as a memory for working when the low-resolution image data is converted into the high-resolution image data according to the resolution conversion program. Also, as mentioned above, the image data received from the outside by the transmitting and receiving unit 214 may be stored if necessary.

The CPU 216 executes various programs stored in the programmable ROM 220 for executing various functions of the portable terminal device 210. In particular, according to the present embodiment, the CPU 216 reads and executes the resolution conversion program stored in the programmable ROM 220 to convert the low-resolution image data into the high-resolution image data. Further, the CPU 216 reads and executes the image display program stored in the programmable ROM 220 to display image data (including the low-resolution image data and the high-resolution image data) on the display device 212. Furthermore, the CPU 216 executes various programs other than the above programs for realizing various functions of the portable terminal device 210. However, because these functions are not directly related to the present invention, description thereof will be omitted.

Hereinafter, for convenience's sake, the image data corresponding to the conventional screen size of about 120×160 pixels in horizontal and vertical directions is called as the low-resolution image data. The image data corresponding to the screen size of about 240×320 pixels in horizontal and vertical directions is called the high-resolution image data. Also, the image data corresponding to the screen size of about 240×320 pixels obtained by converting the low resolution data according to the resolution converting method according to the present invention is called as the pseudo-high-resolution image data.

Next, a resolution conversion step according to this embodiment and the corresponding viewing angle range adjustment step will be explained.

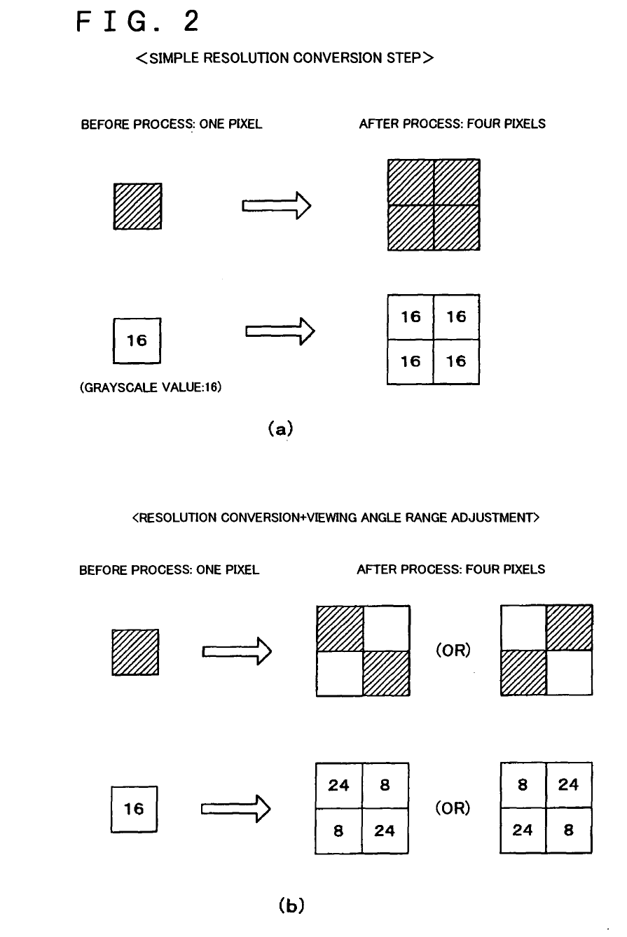

Firstly, FIG. 2(a) shows schematically a simple resolution conversion step that is not accompanied by a viewing angle range adjustment. Resolution conversion shown in FIG. 2(a) is an example of resolution conversion in which one pixel is converted into four pixels by enlarging by two times in the horizontal and vertical directions. In this case, four pixels before the process are simply adjoined to create four-pixel image data. In the simple resolution conversion step, the grayscale values of the pixels before and after the process are not different. For instance, in the example of FIG. 2(a), supposing that the grayscale value of one pixel before the process is (16), all of the grayscale values of four pixels after the resolution conversion step remain (16). Therefore, it is impossible to improve the viewing angle range.

Next, FIG. 2(b) shows schematically a resolution conversion step method to which a basic viewing angle range adjustment is adapted. As mentioned above, a TN mode liquid crystal has a narrow vertical viewing angle range. Thus, as a method for widening a vertical viewing angle range in the vertical direction, a method of making a grayscale difference between pixels arranged in the vertical direction is widely known. In one typical example of such a method, as shown in FIG. 2(b), when one pixel is enlarged by a resolution conversion step, the grayscale values of pixels arranged in the vertical direction are difference each other. In an example of FIG. 2(b), supposing that the grayscale value of one pixel whose resolution is to be converted is (16) and the one pixel is converted into four pixels by enlarging the pixel by two times in the horizontal and vertical directions, the grayscale values of the four pixels become different from each other in such a way that they does not become (16) but become (24) and (8), for example. And, a pair of pixels with different grayscale values is arranged parallel to in the vertical direction. In an example of FIG. 2(b), the pixel with a grayscale value of (8) and the pixel with a grayscale value of (24) are arranged parallel to in the vertical direction.

In this regard, a vertical viewing angle range can be improved by carrying out resolution conversion by enlarging one pixel such that the grayscale values of the pixels arranged in the vertical direction are different from each other. Fundamentally, the larger the difference between the grayscale values of the adjacent pixels in the vertical direction becomes, the higher the degree of increase of viewing angle range becomes. Hence, when carrying out the resolution conversion step, the degree of improvement of viewing angle range can be adjusted by adjusting the difference between the grayscale values of the adjacent pixels in the vertical direction. In addition, the effect of resolution improvement can be surely acquired by giving at least a predetermined difference in grayscale value between the adjacent pixels in the vertical direction.

As mentioned above, in case that one pixel is enlarged to four pixels of 2×2 by resolution conversion step, a vertical viewing angle range can be improved by arranging the pixels in such a manner that the grayscale values of the pixels disposed in a vertical direction are different.

However, in an actual TM mode liquid crystal, it is known by measurement that the viewing angle range dependence for each of R (Red), G (Green), and B (Blue) colors are different. Since one pixel consists of sub pixels of R, G, and B, a proper viewing angle range adjustment for each color can be carried out by setting the grayscale values of the sub pixels arranged in the vertical direction to be different for each of RGB colors by using the resolution conversion step.

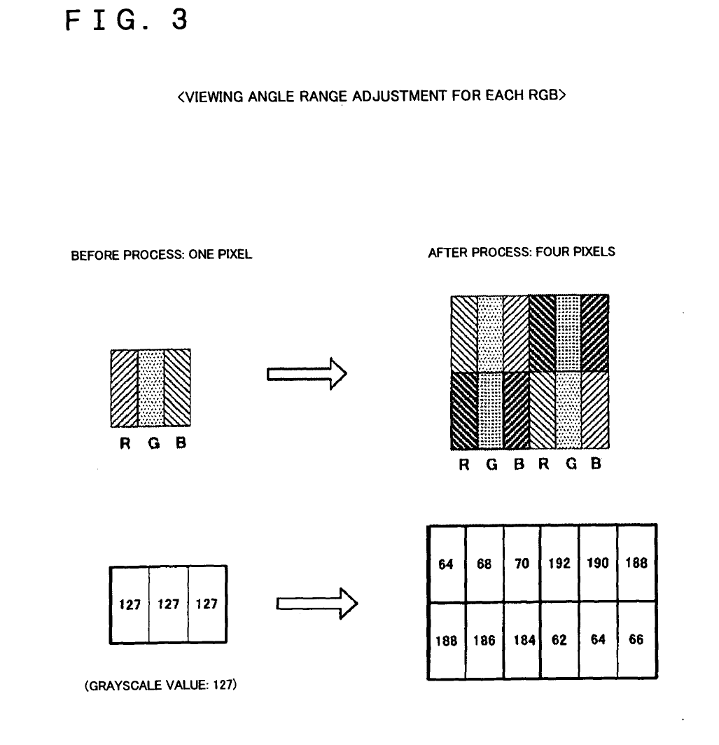

FIG. 3 shows an example of resolution conversion step for adjusting the grayscale value for each of sub pixels of RGB. It is supposed that the grayscale value of one pixel before resolution conversion was (127) for each of RGB. In the four pixels after the resolution conversion as shown in FIG. 3, the sub pixel of R at the leftmost has a grayscale value of (66) at an upper side and a grayscale value of (188) at a lower side, while the sub pixel of B at the right from the sub field of R has a grayscale value of (68) at an upper side and a grayscale value of (186) at a lower side. The sub pixel of B at the right from the sub field of G has a grayscale value of (70) at an upper side and a grayscale value of (184) at a lower side. In this way, a proper viewing angle range adjustment can be carried out for each color by varying allocation of the grayscale values of the sub pixels for each color of RGB after the resolution conversion. As a result, a moire of unnecessary color shown by a viewing angle range can be eliminated.

Next, a method for adjusting a viewing angle range in consideration of the display characteristics, more concretely, such as gamma (γ) characteristics or tone characteristics, of the display device will be described. In the above-mentioned method, a viewing angle range is widened by giving a grayscale value difference, that is, a brightness difference, to the grayscale values of pixels arranged in a vertical direction. However, how large grayscale value difference will be good actually is determined by experimentally or statistically.

With respect to this, it is possible to carry out a viewing angle range adjustment suitable for a display device in use by determining how large grayscale value difference will be given actually in consideration of the physical display characteristics of the display device, more concretely, the gamma characteristics or tone characteristics thereof. This method will be explained hereinafter.

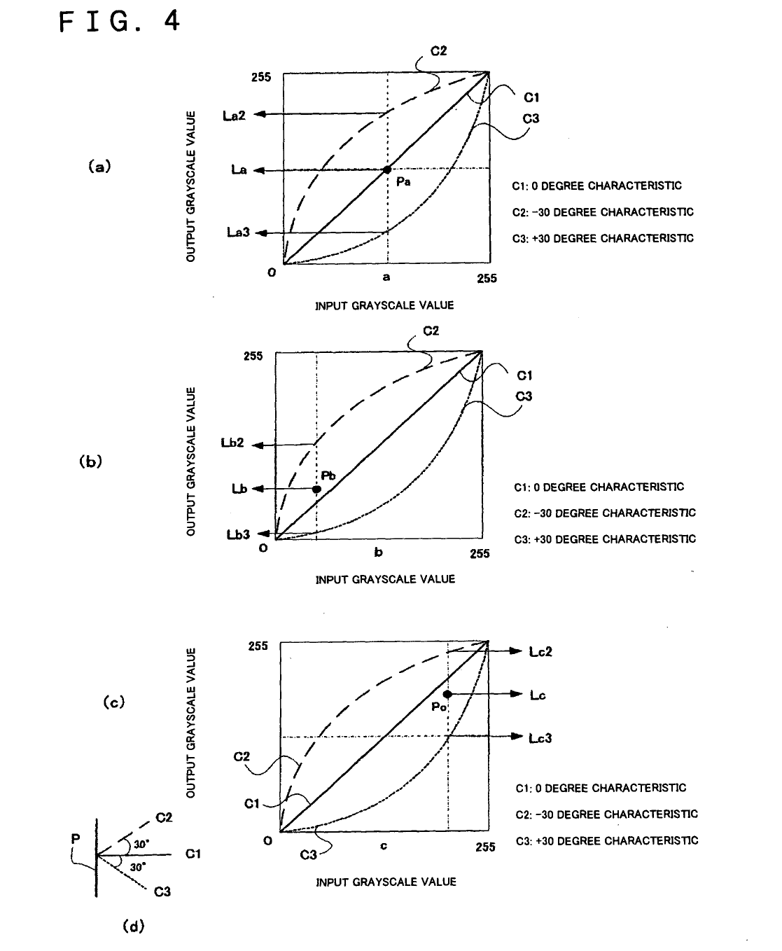

FIG. 4(a) shows an example of transmissibility characteristics (tone characteristics) of a certain TN mode liquid crystal panel. The tone characteristics are characteristics which show what level (grayscale value) of output can be actually obtained when giving a certain level (grayscale value) input to a target liquid crystal panel. As shown in FIG. 4(a), an input grayscale value is shown on a horizontal axis and an output grayscale value is shown on a longitudinal axis.

In FIG. 4(a), characteristic C1 is a tone characteristic in a case where a liquid crystal panel surface is observed from a vertical direction (0 degree direction), characteristic C2 is a tone characteristic in a case where a liquid crystal panel surface is observed from a −30 degrees direction, and characteristic C3 is a tone characteristic in a case where a liquid crystal panel surface is observed from a +30 degrees direction.

Further, FIG. 4(d) shows schematically a relation between the liquid crystal panel surface and the observation directions corresponding to the characteristics C1 to C3. In FIG. 4(d), the characteristics obtained by observing from a vertical, −30 degrees and +30 degrees directions with respect to the liquid crystal panel surface P refers as the characteristics C1 to C3, respectively.

As shown in FIG. 4(a), for the characteristic C1 corresponding to the observation direction of 0 degree, an input grayscale level and an output grayscale value are almost proportionate to each other, while the characteristic C2 corresponding to the observation direction of −30 degrees, an output pixel value is curved to a bright side. On the contrary, for the characteristic C3 corresponding to the observation direction of +30 degrees, an output pixel value is curved to a dark side. That is, when viewing the liquid crystal panel surface P from a 0 degree observation direction, pixels having brightness almost proportionate to an input pixel value can be observed. But, the same pixels look to be fairly bright when observing them from −30 degrees observation direction. In addition, the same pixels look to be fairly dark when observing them from a +30 degrees direction.

When observing the liquid crystal panel actually, the observation direction often changes within a range of ±30 degrees. Thus, even in case that there occurs such a change of observation direction, it is preferable that certain pixels be shown to have the same brightness as possible or at least they be not shown to be extremely bright or dark.

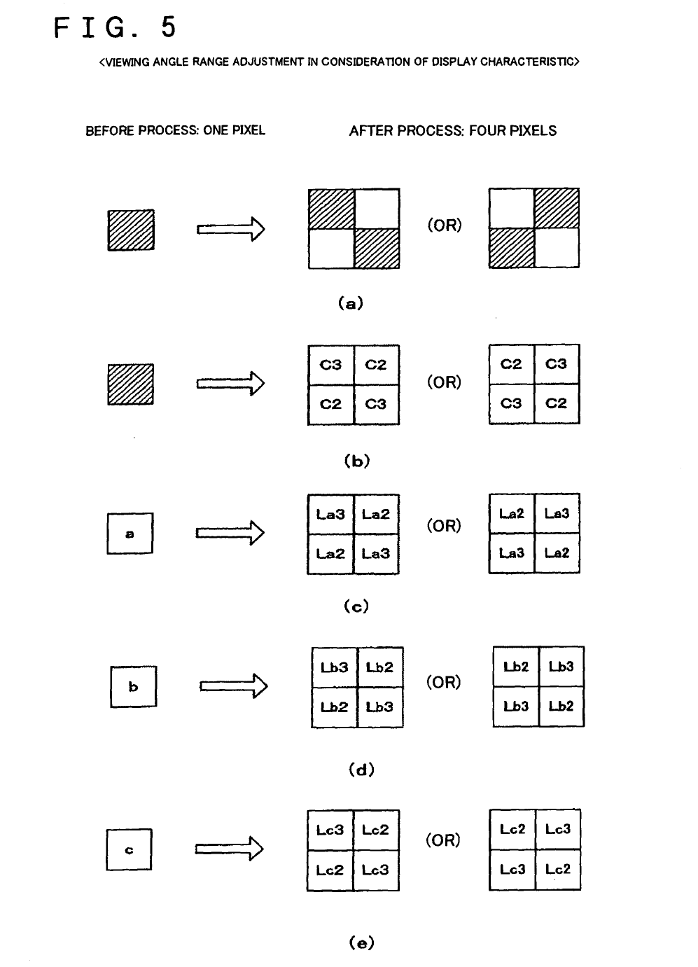

Therefore, in this example, as shown in FIGS. 5(a) and 5(b), when one pixel is enlarged to four pixels by resolution conversion, one of the two adjacent pixels in a vertical direction is set to have a grayscale value corresponding to the characteristic C2 and the other is set to have a grayscale value corresponding to the characteristic C3. In this regard, an observer observing the liquid crystal panel can observe the pixels at the average grayscale value (i.e., the average brightness) of the grayscale values with the characteristics C2 and C3.

For instance, in the tone characteristics of FIG. 4(a), in case that one pixel having a grayscale value of (a) converts into four pixels by resolution conversion, as shown in FIG. 5(c), the grayscale value of the pixel corresponding to the characteristic C2 becomes (La2) and the grayscale value of the pixel corresponding to the characteristic C3 becomes (La3). Therefore, when watching these four pixels together, the observer perceives the pixel as grayscale value (La) which is an average grayscale value of both grayscale values (corresponding to point Pa of FIG. 4(a)), and the observer perceives the pixel as a grayscale value which is an intermediate grayscale value between the characteristics C2 and C3.

In the above example, the input grayscale value (a) is an intermediate luminance level. On the other hand, FIG. 4(b) shows a case that the input grayscale value is a dark luminance level (b). In this case, as shown in FIG. 5(d), the grayscale value of the pixel corresponding to the characteristic C2 becomes (Lb2) and the grayscale value of the pixel corresponding to the characteristic C3 becomes (Lb3). Hence, when watching these four pixels together, the observer perceives the pixel as (Lb) which is an average grayscale value of both grayscale values (corresponding to point Pb of FIG. 4(b)), perceives the pixel as a grayscale value which is an intermediate grayscale value between the characteristics C2 and C3. In this case, since an output grayscale value (Lb3) obtained by the characteristic C3 is fairly dark, while an output grayscale value (Lb2) obtained by the characteristic C2 is bright, it is possible to overcome a problem in that the pixels are displayed too darkly as only in the characteristic C3.

On the contrary, FIG. 4(c) shows a case that an input grayscale value is a bright luminance level (c). In this case, as shown in FIG. 5(e), the grayscale value of the pixel corresponding to the characteristic C2 becomes (Lc2) and the grayscale value of the pixel corresponding to the characteristic C3 becomes (Lc3). Hence, when watching these four pixels together, the man perceives the pixel as “Lc” which is an average grayscale value of both grayscale values (corresponding to point Pc of FIG. 4(c)), the observer perceives the pixel as a grayscale value which is an intermediate grayscale value between the characteristics C2 and C3. In this case, since an output grayscale value (Lc2) obtained by the characteristic C2 only is fairly bright while an output value (Lc3) obtained by the characteristic C3 is darker than (Lc2), it is possible to overcome a problem in that the pixels are displayed too brightly as in the characteristic C2 only.

As described above, when one pixel is enlarged to four pixels by resolution conversion, one of the two adjacent pixels in a vertical direction is set to have a grayscale value corresponding to the tone characteristic C2 corresponding to a −30 degrees observation direction and the other is set to have a grayscale value corresponding to the tone characteristic C3 corresponding to a +30 degrees observation direction. In this regard, the observer observing the four pixels after the enlargement can observe the pixels at the average luminance level (i.e., the average brightness) of the characteristics C2 and C3, thus a problem in that the pixels are watched to be too dark or too bright does not occur. In addition, practically, the direction of the liquid crystal panel or the direction of the observer's sight is changed somewhat during the observation. However, even if they are changed somewhat (precisely, within a range of ±30 degrees), the brightness of pixels observed by the eyes of the observer are maintained between the characteristics C2 and C3, and thus a problem in that the pixels are watched too dark or too bright does not occur. Hence, such a method is a method for performing a proper viewing angle range adjustment with respect to the liquid crystal panel based on the physical characteristics of the targeted liquid crystal panel.

Moreover, as determination step of actual grayscale values, firstly, the characteristics C2 and C3 shown in FIG. 4(a) are previously stored in a lookup table (LUT) or the like. Further, when one pixel to be enlarged by resolution conversion is set, the determination step refers to the LUT and acquires the output grayscale value corresponding to the grayscale values thereof for the characteristics C2 and C3, to assign to the grayscale values of the four pixels after the enlargement (refer to FIG. 5).

In the above explanation, the tone characteristics as shown in FIG. 4(a) are common for each of RGB colors. Practically, as described above, since it is known that the viewing angle range characteristics are different according to each color of RGB, it is more preferable to prepare different tone characteristics for each color of RGB, to store them in the LUT, and to set a grayscale value for each color. Further, in this case, the grayscale value is determined with reference to the tone characteristics in the LUT corresponding to the sub pixels of RGB constituting one pixel.

Although the above example uses the characteristics corresponding to a ±30 degrees observation method with respect to the liquid crystal panel surface P, it should be understood that this invention is not limited to this range of angle but it is preferable to determine a grayscale value in consideration of the characteristics for a specific angle at which the user is very likely to observe and according to the structure or use of the portable terminal device to which the present invention is adapted.

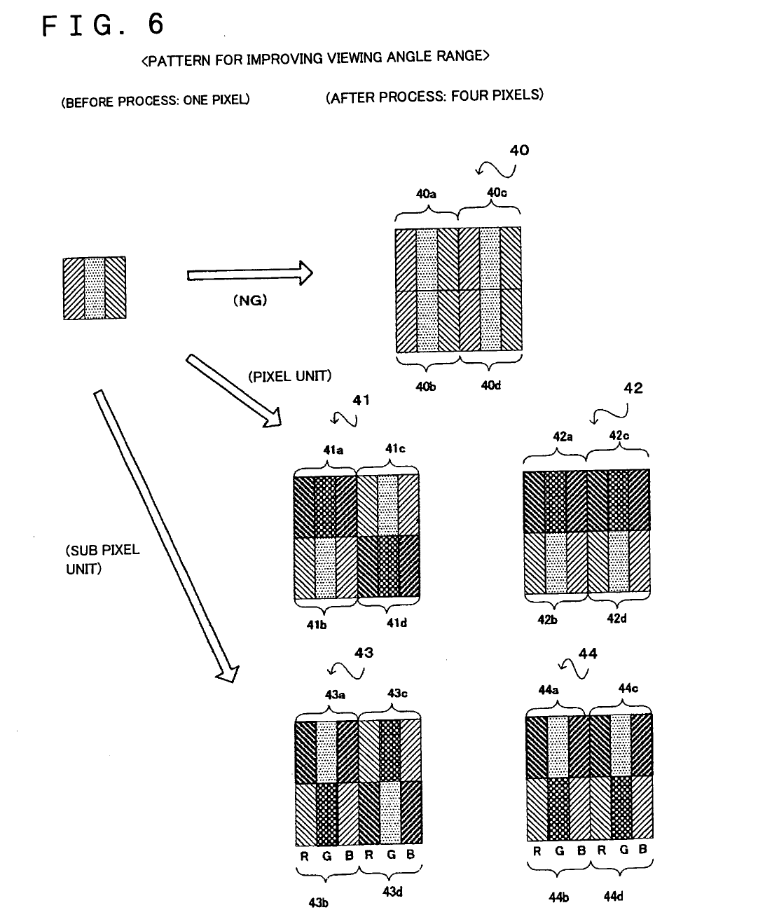

Next, a pattern for improving a viewing angle range will be explained. As described above, basically, for the pixels obtained by resolution conversion, if the adjacent pixels in a vertical direction have a grayscale value with a sufficient difference, the effect of viewing angle range improvement can be acquired. For example, as described above, in a case that one pixel is enlarged into four pixels by resolution conversion, several patterns, as shown in FIG. 6, are considered.

A pattern 40 as in FIG. 6 is one having no difference or a smaller difference between the grayscale values of the adjacent pixels in the vertical direction. So thus, it cannot acquire the effect of viewing angle range improvement.

Patterns 41 and 42 are ones having a difference between the grayscale values of the adjacent pixels in the vertical direction in pixel unit. Specifically, in the pattern 41, a pixel 41a at an upper left side and a pixel 41d at a lower right side have low grayscale values. A pixel 41b at a lower left side and a pixel 41c at an upper right side have high grayscale values. In the pattern 42, two pixels 42a and 42c at an upper side have low grayscale values and two pixels 42b and 42d at a lower side have high grayscale values. On the contrary, a pattern can be considered in which the two pixels 42a and 42c at the upper side have high grayscale values and the two pixels 42b and 42d at the lower side have low grayscale values. In this way, in the method for giving a grayscale value difference in a vertical direction in pixel unit, it is possible to obtain an effect of resolution improvement. Basically, the larger the difference between the grayscale values of the pixels in the vertical direction becomes, the higher the effect of resolution improvement becomes.

Patterns 43 and 44 are ones that give a grayscale value difference in the vertical direction not in pixel unit but in sub pixel unit. Sub pixels are units of constituting one pixel, and are typically configured by a display area for any one of RGB colors. The sub pixels of RGB gather to form one pixel.

In the pattern 43 as shown in FIG. 6, the sub pixels R and B of a pixel 43a at an upper left side have low grayscale values and the sub pixels of G thereof have high grayscale values. Meanwhile, the sub pixels of R and B of a pixel 43b at a lower left side have high grayscale values and the sub pixels of G thereof have low grayscale values. In this way, a vertical viewing angle range is improved also by giving a grayscale value difference in the vertical direction in sub pixel unit. In the pattern 44, all of sub pixels constituting two pixels 44a and 44c at an upper side have low grayscale values and all of sub pixels constituting two pixels 44b and 44d at a lower side have high grayscale values. This pattern also may be a pattern whose vertical direction is reversed.

In this regard, the method of giving a grayscale value difference in the vertical direction in sub pixel unit is advantageous in that the pattern having a grayscale value difference can be made difficult to be seen by the eyes of the man as compared to the method of giving a grayscale value difference in the vertical direction in pixel unit. That is, if the resolution of a pattern can be set at a spatial frequency higher than the resolution of the eyes of a man, a grayscale value difference in that pattern, i.e., the brightness of the sub pixels, is not perceived by the eyes of the man. Therefore, if the pattern having a grayscale value difference in the vertical direction in sub pixel unit is used, it is possible to make a change of brightness in the pattern not noticed and to improve a viewing angle range.

Additionally, when a pixel is enlarged by two times in the horizontal and vertical directions by resolution conversion, in case of arranging a pixel which have the same grayscale value in the horizontal direction as the pattern 42 or 44, it is possible to share the same data by two adjacent pixels, drive the pixels and perform a display depending upon a method of driving a liquid crystal display panel. Therefore, in this case, the use of the pattern 42 or 44 can lead to low power consumption.

Next, display control step using the above resolution conversion step will be explained. In addition, the display control step to be explained hereinafter is conducted by executing a display control program and a resolution conversion program previously prepared in the programmable ROM 220 by the CPU 216 of the portable terminal device 210 shown in FIG. 1.

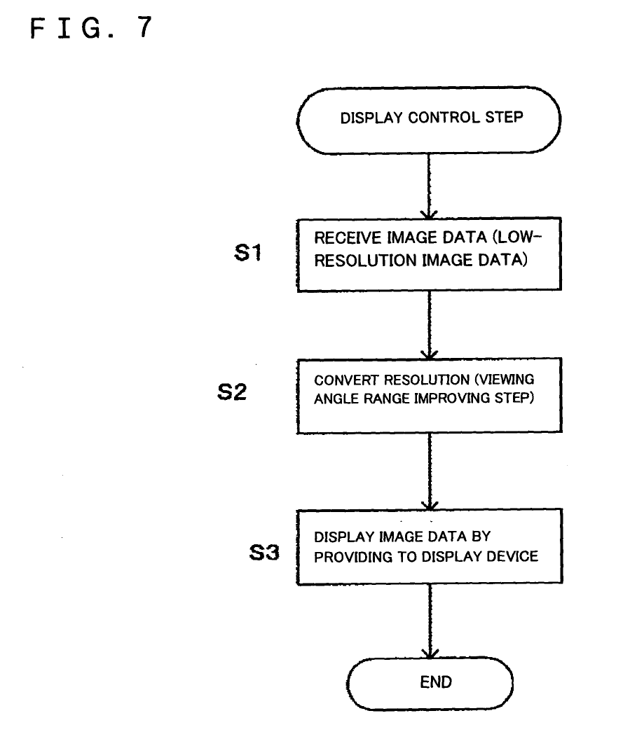

FIG. 7 shows a flow chart of display control step to be performed in the portable terminal device 210. Firstly, the portable terminal device 210 receives image data to be displayed from an external server (Step S1). In this case, the received image data is low-resolution image data having a number of pixels lower than the resolution of the display device 212 in the portable terminal device 210.

The CPU 216 performs a resolution conversion with respect to the received low-resolution image data (Step S2). Specifically, for example, a step for enlarging one pixel into four pixels is performed by any one of methods as shown in FIGS. 2 to 6. At the same time, an image data (refer to resolution-converted image data) is created as the result of the improvement of viewing angle range by giving a grayscale value difference in pixel unit or sub pixels in a vertical direction (Step S2). Then, the CPU 216 can provide such a created resolution-converted image data to the display device 212 to display (Step S3). In this way, the portable terminal device 210 can receive low-resolution image data, converts it into high-resolution image data and display it without incompatibility. Moreover, at this time, since the improvement of viewing angle range is performed by any one of the methods described above, the image data displayed after resolution conversion can have a wide viewing angle range.

Next, a display control step in case that the same portable terminal device 210 selects one between a wide angle field mode and a narrow angle field mode will be explained. In the portable terminal device using a liquid crystal panel, a wider viewing angle range is generally preferable because the user can view easily. However, for example, in case of a mobile phone, the user often watches display contents in an environment, such as an electric railroad which is crowded with people. Thus, there is a need for making a viewing angle range narrower so that people in the vicinity or at the opposite side cannot see the display contents. Hence, in the display control step herein below, the user can select one between a wide viewing angle range and a narrow viewing angle range.

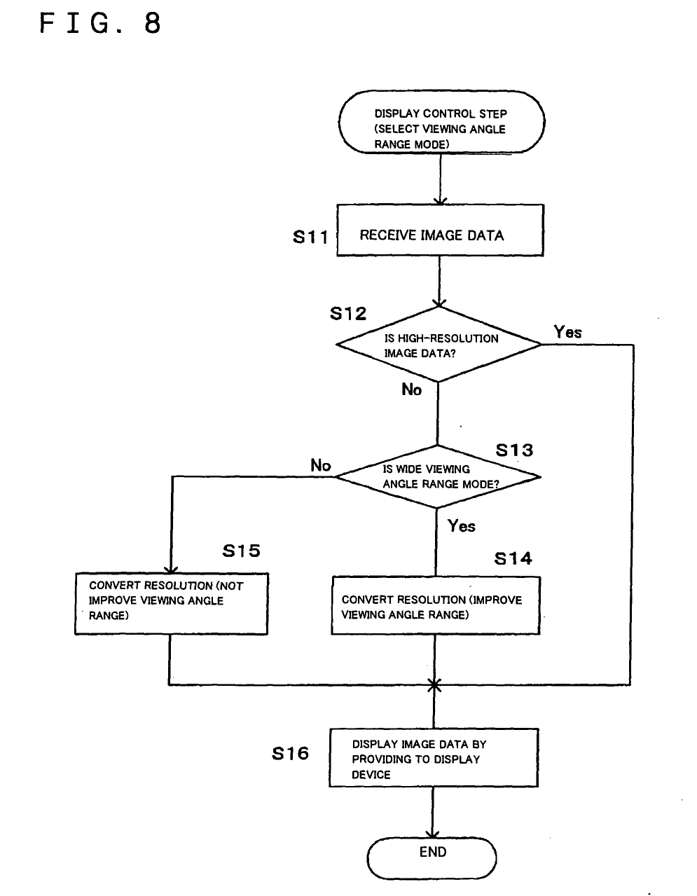

FIG. 8 is a flow chart of a display control step employing such a viewing angle range mode selection. Firstly, the CPU 216 receives image data to be displayed from an external server (Step S11). Then, it is determined whether the received image data is high-resolution image data or low-resolution image data (Step S12). Additionally, the high-resolution image data is image data having a number of pixels suitable for a number of displayed pixels of the display device 212 in the corresponding portable terminal device 210.

In case of receiving the high-resolution image data (Step S12; Yes), since resolution conversion is not needed, the image data is displayed as it is and then the routine proceeds to the step S16 to be described later. Meanwhile, in case of receiving the low-resolution image data (Step S12; No), the CPU 216 determines whether the user has selected the wide viewing angle range or not at this point of time (Step S13). Also, the user can select one between the wide viewing angle range mode and the narrow viewing angle range mode by manipulating the input unit 218 of the portable terminal device 210.

In case that the wide viewing angle range mode is selected (Step S13; Yes), the CPU 216 performs a resolution conversion as same as the display control step of FIG. 7. Further, it performs a resolution improvement step by giving a grayscale difference to the pixels in the vertical direction (Step S14).

Meanwhile, in case that the narrow viewing angle range is selected (Step S13; No), the CPU 216 performs a resolution conversion without a viewing angle range improvement step (Step S15). Further, if the viewing angle range improvement step is not performed, the resolution conversion process means that the pixels after the enlargement have no grayscale difference in the vertical direction as shown in FIG. 2(a) or the enlargement of the pixels are performed so as to have only a small grayscale difference.

Finally, the CPU 216 provides the obtained high-resolution image data to the display device 212 and displays it. By the above step, in case that the user has selected the wide viewing angle range mode, the image data after the resolution conversion has a wide viewing angle range. On the other hand, in case that the user has selected the narrow viewing angle range mode, the image data after the resolution conversion have a narrow viewing angle range as a result that the improvement of a viewing angle range has not achieved.

The above description is an example in which a vertical viewing angle range is improved in consideration of the property that the TN mode liquid crystal basically has a narrow vertical viewing angle range. However, it is also possible to improve a horizontal viewing angle range by the same method. In this case, a sufficient grayscale difference is given as much as the grayscale values of the adjacent pixels in the horizontal direction among the pixels acquired after resolution conversion.

In the embodiments describe above, an electro optical device using the liquid crystal (LC) as an electro optical material is described as an example. For examples, well-known material comprising TN (Twisted Nematic) type, STN (Super Twisted Nematic) type, and BTN (Bi-stale Twisted Nematic) type having a twisting direction more than 180 degrees, Couple-stable type, high polymer dispersing type, and guest-host type with memorization of ferroelectric type can be used as the liquid crystal. Moreover, the present invention can be applied to an active matrix type panel using two-terminal switching devices of Thin Film Diode in addition to a three-terminal switching device of Thin Film Transistor. In addition to the above mentioned devices, the present invention can be applied to a passive matrices type panel without using the switching device. Moreover, the present invention can be applied to electro optical materials except for the liquid crystal, for examples, an electroluminescent (EL), digital micro mirror device (DMD), or various electro optical devices using a fluorescence lamp by the plasma light-emission or the electron emission.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. An image display device, comprising:
a display unit;
a resolution conversion device that makes a plurality of pixels from each pixel of original image data and generates resolution-converted image data including the plurality of made pixels;
a viewing angle range adjustment device that sets grayscale values of each pixel of the resolution-converted image data so that the grayscale values of adjacent pixels in a vertical direction of the resolution-converted image data are different from each other; and
a display device for displaying the resolution-converted image data on the display unit.

2. The image display device according to claim 1, the viewing angle range adjustment device setting the difference between grayscale values of the adjacent pixels in the vertical direction to be more than a predetermined grayscale value.

3. The image display device according to claim 1, the viewing angle range adjustment device setting the grayscale values of each of the pixels based on display characteristics of the display unit.

4. The image display device according to claim 3, the viewing angle range adjustment device comprising:
a lookup table that stores the display characteristics of the display unit; and
a device that determines the grayscale value of each pixel with reference to the lookup table.

5. The image display device according to claim 1, the viewing angle range adjustment device setting the grayscale values of sub pixels constituting each pixel of the resolution-converted image data such that adjacent sub pixels in the vertical direction have different grayscale values.

6. The image display device according to claim 5, the viewing angle range adjustment device comprising:
a lookup table that stores display characteristics of the display unit for each color of R, G, and B; and
a device that determines the grayscale values of the sub pixels for each color with reference to the lookup table.

7. The image display device according to claim 1, further comprising:
an input unit that receives a command to select one of a wide viewing angle range and a narrow viewing angle range, the display device displays the resolution-converted image data adjusted by the viewing angle range adjustment device if the wide viewing angle range mode is selected and displays the resolution-converted image data not adjusted by the viewing angle range adjustment device if the narrow viewing angle range mode is selected.

8. An image display method to be executed in an image display device with a display unit, comprising:
making a plurality of pixels from each pixel of original image data and generating resolution-converted image data including the plurality of made pixels;
setting a grayscale value of each pixel of the resolution-converted image data so that the grayscale values of adjacent pixels in the vertical direction of the resolution-converted image data are different from each other; and
displaying the resolution-converted image on the display unit.

9. An image display program to be executed in the image display device having a display unit and a computer, the image display program making the computer function as:
a resolution conversion device that makes a plurality of pixels from each pixel of original image data and generates resolution-converted image data including the plurality of made pixels;
a viewing angle range adjustment device that sets a grayscale value of each pixel of the resolution-converted image data so that the grayscale values of the adjacent pixels in the vertical direction of the resolution-converted image data are different from each other; and
a display device that displays the resolution-converted image on the display unit.
